(19) United States
(12) Patent Application Publication
(10) Pub. No.: US 2018/0272877 A1
(43) Pub. Date: Sep. 27, 2018

(54) Electric Vehicle with Thermal Management System

(71) Applicant: GM GLOBAL TECHNOLOGY OPERATIONS LLC, Detroit, MI (US)

(72) Inventors: Ilia Alexander Sakowski, Eltville am Rhein (DE); Markus Frommann, Bingen am Rhein (DE)

(73) Assignee: GM GLOBAL TECHNOLOGY OPERATIONS LLC, Detroit, MI (US)

(21) Appl. No.: 15/935,808

(22) Filed: Mar. 26, 2018

(30) Foreign Application Priority Data
Mar. 24, 2017 (DE) 102017002854.0

(51) Int. Cl. B60L 11/18; B60H 1/00; H01M 16/00; H01M 10/625; H01M 10/63; H01M 10/6556; H01M 10/663; H01M 8/04007; H01M 10/613; H01M 10/615

(52) U.S. Cl. CPC B60L 11/187; H01M 2250/405; H01M 16/006; H01M 10/625; H01M 10/63; H01M 10/6556; H01M 10/663; H01M 8/04067; H01M 10/613; H01M 10/615; B60L 2240/36; B60H 2001/00307; H01M 2220/20; H01M 2250/20; B60H 1/00278

(57) ABSTRACT

An electric vehicle includes a thermal management system, an electric drive, a traction battery electrically coupled to the electric drive and a thermal energy source thermally coupled to the traction battery. Thermally coupling the thermal energy source and traction battery makes it possible to keep the area surrounding the traction battery and the traction battery itself at a temperature level where the traction battery can be efficiently operated. The waste heat of the thermal energy source may be used directly for heating up the vehicle interior and/or for controlling the temperature of the traction battery. Making direct use of provided waste heat that might arise in the motor vehicle anyway proves to be particularly energy efficient.

### CROSS-REFERENCE TO RELATED APPLICATION

This application claims priority to German Patent Application No. 102017002854.0, filed Mar. 24, 2017, which is incorporated herein by reference in its entirety.

### TECHNICAL FIELD

The present disclosure pertains to an electric vehicle with a thermal management system. In particular, the development relates to a motor vehicle having at least one electric drive and equipped with a thermal energy source. In addition, the development further relates to a method for controlling the temperature of a traction battery of a motor vehicle.

### BACKGROUND

Battery or accumulator powered electric vehicles typically have a traction battery, with which the electric energy necessary for an electric drive can be stored. The service life and capacity of such traction batteries are temperature dependent. Maximum efficiency and full electric charging capacity for such traction batteries is typically only given within a tight temperature window. In especially cold weather conditions, most commercially available traction batteries, such as lithium ion accumulators, have an elevated internal resistance, which can result in lost capacity.

Due to the comparatively high internal resistance at low temperatures, thermal energy is generated in the area of the battery during the output of electric power and due to the elevated power loss. However, this takes place subject to elevated wear on the battery, and can be accompanied by a premature ageing of the traction battery.

### SUMMARY

In accordance with the present disclosure an improved thermal management system is provided for a motor vehicle, in particular for an electric vehicle, which counteracts the premature ageing processes of a traction battery, and which allows the traction battery to operate as efficiently as possible. The goal is here to increase the range of the motor vehicle and to use the provided electric capacity of the traction battery as optimally as possible.

The present disclosure provides a motor vehicle with at least one electric drive, a traction battery and a thermal energy source. The traction battery can here be electrically coupled with the drive. The thermal energy source can further be thermally coupled with the traction battery. Even under inclement weather conditions and at comparably low temperatures, thermally coupling the thermal energy source and traction battery makes it possible to keep the area surrounding the traction battery and the traction battery itself at a temperature level where the traction battery can be efficiently operated.

Using waste heat of the energy source for controlling the temperature of the traction battery makes it possible to extend the service life of the traction battery. In addition, the electric capacity of the traction battery can be taken fully advantage of for the drive. The thermal energy source can further be used to heat up the motor vehicle interior, so that the motor vehicle interior is no longer heated up at the expense of the traction battery or other battery systems of the motor vehicle in a purely electrically driven motor vehicle. The electric charging capacity of the traction battery can in this way be used to an elevated extent for driving the motor vehicle. In this way, the motor vehicle range can be increased.

It is here provided in particular that the waste heat of the thermal energy source be used directly for heating up the vehicle interior and/or for controlling the temperature of the traction battery. Making direct use of provided waste heat that might arise in the motor vehicle anyway proves to be especially energy efficient.

In a further development, the thermal energy source has a fuel cell for generating electric energy. For example, the fuel cell may be configured to generate electric energy that is fed into the traction battery. The electric energy producible by the fuel cell can also be used for other energy consumers, for example for an electric heater or an electric cooler. Operating the fuel cell to supply electric energy generates waste heat, which can be used directly for controlling the temperature of the traction battery and/or controlling the temperature of the motor vehicle interior.

As a consequence, the thermal energy source can simultaneously be an electric energy source, which is electrically coupled with the traction battery and with an electric drive, for example with an electric motor. Electric coupling can here take place via a DC bus, for example via a so-called common DC bus.

In another embodiment, the motor vehicle has a thermal energy bus. The thermal energy source is here thermally coupled by a heat exchanger with the thermal energy bus. The thermal energy bus is further thermally coupled with the traction battery. Even more thermal components can be thermally coupled to the thermal energy bus, such as a heater and/or an air conditioner, or a cooler of the motor vehicle. The thermal energy bus can be used for redistributing thermal energy inside of the motor vehicle. The thermal energy bus can be heated or cooled to a prescribed desired temperature, and can use a suitable heat exchanger medium to set the temperature of the components thermally connected to the thermal energy bus to a prescribed temperature level.

For example, the thermal energy bus can have an open or closed cycle. A thermal exchanger medium circulates through the latter. Individual components connected to the thermal energy bus can supply thermal energy to the thermal energy bus, or remove thermal energy from the thermal energy bus. The thermal energy bus enables a thermal management of the motor vehicle, so that the waste heat arising in the motor vehicle anyway can be used for increasing the efficiency of motor vehicle operation, in particular for increasing service life and optimally operating a traction battery.

In another embodiment, the motor vehicle has a heater, which is thermally coupled with the thermal energy bus. The heater can be implemented as an electric heater, which is supplied by a vehicle electric system. The vehicle electric system can be supplied with energy from the fuel cell. The vehicle electric system can also be electrically coupled with the traction battery. If need be and at especially low outside temperatures, the heater can generate electric energy and dispense it to the thermal energy bus. This is advantageous if the waste heat of the thermal energy source, i.e., of the fuel cell, should be inadequate for maintaining a prescribed desired temperature of the thermal energy bus.

In another embodiment, the motor vehicle further has an air conditioner or cooler, which is thermally coupled with the thermal energy bus. The air conditioner can be configured as an electrically operated air conditioner, the operating current of which is made available via the vehicle electric system. The air conditioner can draw thermal energy from the thermal energy bus, so as to keep it at a prescribed temperature level. Thermally coupling the air conditioner or electric cooler is advantageous in particular at high outside temperatures. If need be, the air conditioner can also be used to thermally cool the thermal energy bus, and hence also the traction battery.

In another embodiment, the motor vehicle is further equipped with at least one sensor arranged in the area of the traction battery, in particular with a temperature sensor, and with a regulator, which is coupled in terms of data processing with the sensor. The regulator is configured to maintain a prescribed temperature for the thermal energy bus. The sensor and regulator can be used to specifically set a prescribed desired temperature in the area of the traction battery. This makes it possible to dynamically respond to varying environmental or weather conditions. Given comparatively high outside temperatures, for example, the regulator can be used to decouple the thermal energy source from the thermal energy bus. At especially high outside temperatures, the regulator can be used to couple a cooling capacity of the air conditioner into the thermal energy bus, for example to bring about an active cooling of the traction battery. The at least one sensor, which is typically configured as a temperature sensor, and the regulator connected to it in terms of data processing, can be used to specifically set a prescribed temperature in the area of the traction battery and keep it at a prescribed temperature level.

In another embodiment, the thermal energy bus has at least one circulation member, which can be used to convey a heat exchanger medium from the thermal energy source to the traction battery. The thermal energy bus may be configured in a closed cycle, in which a heat exchanger medium circulates. The circulation of the heat exchanger medium can be specifically controlled by the circulation member. Given a liquid heat exchanger medium, the circulation member may be configured as a pump, for example.

In a gaseous heat exchanger medium, such as air, the circulation member may be configured as a blower. The circulation member can likewise be coupled with the regulator. In this way, the regulator can change the intensity of the circulation member, for example its conveying capacity, as needed as a function of a deviation between an actual temperature measured in the area of the traction battery and a prescribed desired temperature, so as to specifically control a quantity of heat to be transferred via the thermal energy bus.

In another embodiment, the regulator is coupled in terms of data processing with the heater, with the air conditioner and/or with the circulation member. The regulator is typically coupled both with the heater, with the air conditioner and with the circulation member. The regulator can use the data coupling to actuate the heater, air conditioner and/or circulation member. In particular, coupling the regulator with the heater, air conditioner and/or circulation member enables control of the quantity of energy transferred or to be transferred via the thermal energy bus to the traction battery.

The regulator is configured to establish a selective thermal coupling of the traction battery, thermal energy source, heater and/or air conditioner with the thermal energy bus, depending on the prevailing temperature in the area of the traction battery, depending on the temperature of the thermal energy bus or its heat exchanger medium, and also depending on the thermal energy provided by the air conditioner and/or heater.

In addition thereto, the regulator may be configured to control the conveyance of heat exchanger medium by the circulation member as needed, depending on the prevailing temperature in the area of the traction battery, thermal energy source, thermal energy bus, heater and/or air conditioner.

In another embodiment, the motor vehicle has a vehicle electric system, which is electrically coupled with the thermal energy source and with the traction battery. The thermal energy source can serve primarily to feed electric energy into the vehicle electric system. As a consequence, the thermal energy source can also be implemented as a range extender for the purely electric drive of the motor vehicle. The waste heat that arises in the area of the thermal energy source for generating electric energy can be used for controlling the temperature of the traction battery through the thermal coupling with the thermal energy bus. The overall energy balance and efficiency of the motor vehicle can be increased in this way.

In particular, the thermal energy source can be viewed as an electric generator, whose operation on the one hand generates electric energy, which is made available to the traction battery and thus ultimately also to the at least one drive of the electric vehicle. On the other hand, thermal energy is released during operation of the thermal energy source, which can be used to control the temperature of the motor vehicle interior and/or to control the temperature of the traction battery.

In another embodiment, the vehicle electric system is electrically coupled with the air conditioner and/or with the heater, for example in the form of an air-conditioning compressor, and/or the heater can thus involve an electrically operated air conditioner or an electrically operated compressor and/or an electrically operable heater. An electrically operable air conditioner and/or an electrically operable heater can be smoothly integrated into a purely electrically operated motor vehicle. The additional power consumption for air conditioning can not only be compensated, but even overcompensated when providing an electric energy-generating thermal energy source, for example a fuel cell.

Another aspect of the present disclosure provides a method for controlling the temperature of a traction battery of a motor vehicle. The method here involves measuring an actual temperature prevailing in the area of the traction battery and comparing the actual temperature with a prescribed desired temperature. Depending on the comparison, thermal energy may by supplied to the area of the traction battery, or thermal energy may be removed from the area of the traction battery. This serves to set the desired temperature in the area of the traction battery. In this regard, a constant temperature can be set and maintained in the area of the traction battery. This can have a positive impact on the service life of the traction battery. In addition, the full electric capacity of the traction battery can be made useable. This can have an advantageous effect on the range of the electrically driven motor vehicle.

In a further development, the waste heat of a fuel cell is used to supply thermal energy in the area of the traction battery. The fuel cell can be implemented primarily for providing and generating electric energy. Using the waste heat that arises during operation of the fuel cell for controlling the temperature of the traction battery can prove especially beneficial from an energy standpoint. The waste heat of the fuel cells is available during operation anyway, and would otherwise have to be removed in a controlled manner from the area of the fuel cell to prevent it from overheating.

In another embodiment, an air conditioner or a stream of fresh air is used for removing thermal energy from the area of the traction battery. The air conditioner may be configured like an electrically implemented air conditioner supplied via a vehicle electric system of the motor vehicle. The durability and service life of the traction battery can be increased through both active and passive cooling.

The described method is configured for operating the thermal management system of an electrically driven motor vehicle described herein. All features and advantages described in relation to the method also apply equally to the motor vehicle and its thermal management system. Conversely, all features and advantages described in relation to the motor vehicle and its thermal management system also apply equally to the method for controlling the temperature of the traction battery described herein. In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements.

FIG. 1 is a schematic side view of a motor vehicle,

FIG. 2 is a block diagram of a thermal management system of the motor vehicle,

FIG. 3 is another block diagram to illustrate the temperature control of the traction battery and/or a thermal energy bus, and

FIG. 4 is a flowchart of the method for controlling the temperature of the traction battery.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

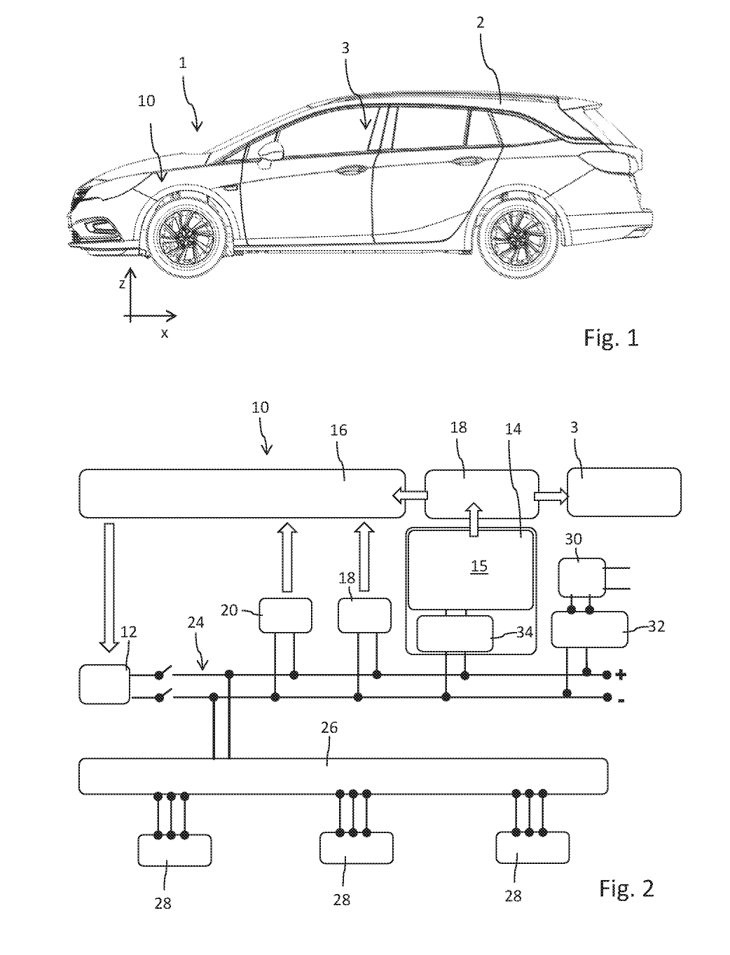

The motor vehicle 1 shown schematically in FIG. 1 in a side view has a motor vehicle body 2 with an interior 3 acting as a passenger compartment. The motor vehicle 1 is equipped with a thermal management system 10, the function of which is explained in more detail based on the block diagram in FIG. 2.

The motor vehicle 1 is equipped with at least one electric drive 28. For example, three electric drives 28 are denoted in FIG. 2 in the form of electric motors. These are coupled by power electronics 26 with a vehicle electric system 24 of the motor vehicle 1. The vehicle electric system 24 can further be connected with the traction battery 12 or is permanently connected with the traction battery 12. The traction battery 12 can provide the electric energy required for operating the drives 28 as appropriate.

Apart from the traction battery 12 and electric drive 28, the motor vehicle 1 is equipped with a thermal energy source 14. The thermal energy source may be configured as an electric generator. In the present exemplary embodiment, it has a fuel cell 15. The fuel cell 15 can be connected with the vehicle electric system 24 of the motor vehicle 1 by a converter 34. During operation of the fuel cell 15, electric energy generated by the fuel cell 15 can be fed into the vehicle electric system 24 of the motor vehicle 1 via the converter 34. The vehicle electric system 24 may be configured as a high-voltage vehicle electric system.

The vehicle electric system 24 can further be connected to another battery 30 via another converter 32. For example, the battery 30 may be configured as a low-voltage battery. For example, it may be configured as a 12 V, 24 V or 48 V battery, so as to supply energy to additional electrical consumers of the motor vehicle 1.

The thermal energy source 14 can further be thermally coupled with a thermal energy bus 16 via a heat exchanger 18. The thermal energy bus 16 is further thermally coupled at least with the traction battery 12. Waste heat that arises in the area of the thermal energy source 14, for example due to operation of the fuel cell 15, can be provided via the heat exchanger 18 and via the thermal energy bus 16 in the area of the traction battery 12, so that, in particular in a start phase of the motor vehicle, the traction battery 12 can be operated in a temperature range in which the traction battery 12 optimally operates. The temperature of the traction battery 12 can typically be controlled by thermal coupling with the thermal energy source 14 to a temperature range in roughly the room temperature range, for example about 72° F. (22° C.).

For extreme weather conditions, given especially low or high outside temperatures, the thermal energy bus 16 can be thermally coupled with an air conditioner 20 and/or with a heater 22. The air conditioner 20 may be configured as an electric air conditioner 20, and can be connected to the vehicle electric system 24 of the motor vehicle 1. In like manner, the heater 22 can be implemented as an electric heater, which is also connected to the vehicle electric system 24 of the motor vehicle 1. If necessary, the air conditioner 20 can be used to remove thermal energy from the thermal energy bus 16 or couple a cooling capacity into the thermal energy bus 16. In like manner, additional thermal energy can be fed into the thermal energy bus 16 via the heater if need be, so as to set and maintain a prescribed desired temperature in the area of the thermal energy bus 16 and/or in the area of the traction battery 12 thermally coupled thereto.

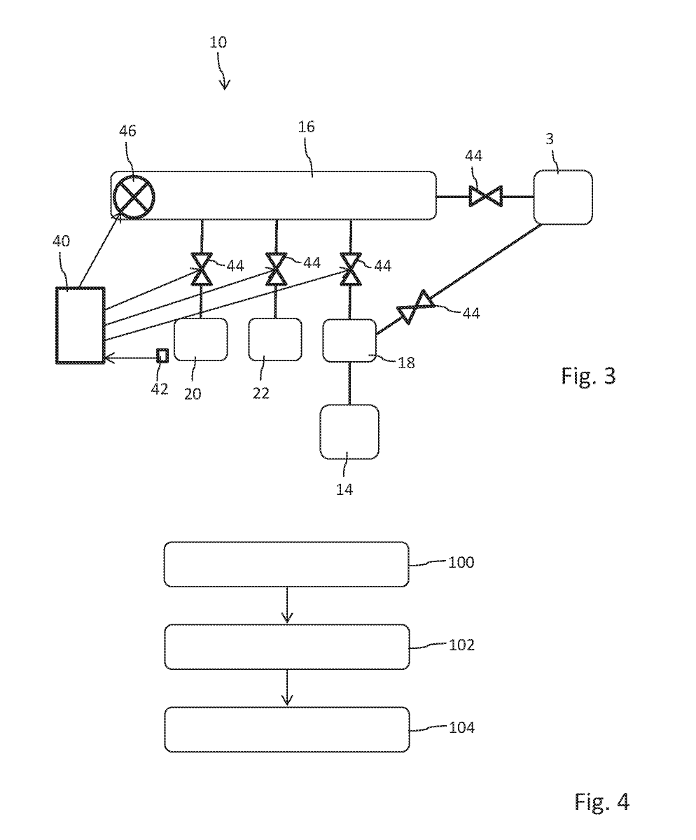

As further denoted in FIGS. 2 and 3, the heat exchanger 18 can be coupled not just with the thermal energy bus 16, but also directly with the interior 3 of the motor vehicle 1. The thermal coupling between the heat exchanger 18, interior 3 and thermal energy bus 18 can be established by a closed cycle, in which a heat exchanger medium, for example a heat exchanger gas or a heat exchanger liquid, circulates. In particular, air is possible as the gaseous heat exchanger. One example for the heat exchanger liquid would be water, if necessary mixed with an antifreeze additive to achieve freezing-point depression.

As schematically illustrated in particular in FIG. 3, the thermal management system 10 has at least one regulator 40 and one sensor 42. The sensor 42 is typically configured as a temperature sensor. It is arranged in the area of the traction battery 12. For example, the prevailing actual temperature in the area of the traction battery 12 can be measured with the sensor 42. The data processing coupling between the regulator 40 and sensor 42 makes it possible to determine the respective prevailing actual temperature of the traction battery 12. In addition to the sensor 42 in the area of the traction battery 12, additional sensors, in particular temperature sensors, can be provided, for example in the area of the heat exchanger 18, in the area of the thermal energy source 14, and also in the area of the air conditioner 20 and/or heater 22.

All sensors can here be coupled with one and the same regulator 40 in terms of data processing. In this regard, the regulator 40 can receive information about the current thermal state of all components of the thermal management system 10. The thermal management system 10 can further be provided with a circulation member 46. The circulation member is typically embedded in the thermal energy bus 16, which may be configured as a closed or, in particular given a gaseous heat exchanger medium, also as an open cycle in which the heat exchanger medium described above circulates. The circulation or circulation rate of the heat exchanger medium in the thermal energy bus 16 can be controlled as needed by means of the circulation member 46. The circulation member 46, for example which is configured as a circulating pump or fan, can be controlled by means of the regulator 40.

For example, if a large temperature difference is measured between an actual temperature measured in the area of the traction battery 12 and a prescribed desired temperature, increasing the flow rate of the heat exchanger medium using the circulation member makes it possible to more quickly harmonize the actual temperature to the prescribed desired temperature.

The process of thermally coupling the heat exchanger 18, air conditioner 20, heater 22 and traction battery 12 to the thermal energy bus 16 can be respectively controlled by at least one valve 44. The valves 44 are typically control valves, which can be actuated from the regulator 40. The valves 44 can be control valves for liquids or throttle valves or butterfly valves for a gas flow. The thermal energy bus 16 can further also be coupled with the interior 3 of the motor vehicle by way of a valve 44. The latter can also be actuated via the regulator 40.

Finally, FIG. 4 shows the method proposed for operating the thermal management system 10 described herein. A prevailing actual temperature is measured in the area of the traction battery 12 at block 100. The measured actual temperature is compared with a prescribed desired temperature at block 102. Based on the comparison, the regulator 40 can initiate corresponding measures for controlling the temperature of the traction battery 12 as needed. If the actual temperature is too low, for example, the heater 22 can be activated at block 104, and the heat additionally provided by the heater 22 can be supplied to the traction battery 12 via the thermal energy bus 16.

Once a prescribed desired temperature has been reached in the area of the traction battery 12, the heater 22 can again be throttled or deactivated, for example. In like manner, the thermal energy continuously emitted by the thermal energy source 14, in particular by its fuel cell 15, can be made available to the traction battery 12 through activation of the circulation member 46 and via the thermal energy bus 16. Should the measured actual temperature in the area of the traction battery 12 clearly exceed the desired temperature in another instance, a thermal energy supply to the thermal energy bus 16 can be throttled, for example through decoupling from the thermal energy source 14. As a result, thermal energy can be drawn from the thermal energy bus 16, for example by activating and thermally coupling the air conditioner 20 with it.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-13. (canceled)

14. A motor vehicle comprising:
at least one electric drive;
a traction battery electrically coupled with the electric drive; and
a thermal energy source thermally coupled with the traction battery.

15. The motor vehicle according to claim 14, wherein the thermal energy source comprises a fuel cell for generating electric energy.

16. The motor vehicle according to claim 14, further comprising a heat exchanger having a thermal energy bus thermally coupled between the thermal energy source and the traction battery.

17. The motor vehicle according to claim 16, further comprising a heater thermally coupled with the thermal energy bus.

18. The motor vehicle according to claim 16, further comprising an air conditioner thermally coupled with the thermal energy bus.

19. The motor vehicle according to claim 16, wherein the heat exchanger is thermally coupled with an interior of the motor vehicle.

20. The motor vehicle according to claim 16, further comprising:
at least one sensor arranged in an area of the traction battery; and
a regulator coupled with the sensor to receive temperature data and operable to maintain a prescribed temperature for the thermal energy bus based on the temperature data.

21. The motor vehicle according to claim 20, wherein the regulator is configured to operate at least one of a heater, an air conditioner and a circulation member.

22. The motor vehicle according to claim 16, wherein the thermal energy bus comprises a circulation member configured to convey a heat exchanger medium between the thermal energy source and the traction battery.

23. The motor vehicle according to claim 14, further comprising a vehicle electric system electrically coupled with the thermal energy source and the traction battery.

24. The motor vehicle according to claim 23, wherein the vehicle electric system is electrically coupled with at least one of an air conditioner and a heater.

25. A motor vehicle comprising:
at least one electric drive;
a traction battery electrically coupled with the electric drive;
at least one sensor arranged in an area of the traction battery for measuring temperature data;
a thermal energy source thermally coupled with the traction battery
a heat exchanger having a thermal energy bus thermally coupled between the thermal energy source and the traction battery; and
a regulator coupled with the sensor to receive temperature data and operable to maintain a prescribed temperature for the thermal energy bus based on the temperature data.

26. A method for controlling the temperature of a traction battery in a motor vehicle comprising:
measuring an actual temperature prevailing in an area of the traction battery;
comparing the actual temperature with a prescribed desired temperature; and
transferring thermal energy to and from the area of the traction battery based on the comparison for maintaining the prescribed desired temperature in the area of the traction battery.

27. The method according to claim 25, further comprising directing a heating fluid having a temperature greater than the actual temperature to the area of the traction battery.

28. The method according to claim 25, further comprising directing a cooling fluid having a temperature less than the actual temperature to the area of the traction battery.
